(19) United States
(12) Patent Application Publication
(10) Pub. No.: US 2017/0337788 A1
(43) Pub. Date: Nov. 23, 2017

(54) ELECTRONIC DEVICE AND ANTI-THEFT METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEI WU, Shenzhen (CN); JUN FENG, Shenzhen (CN); CHIEH-YU LEE, New Taipei (TW); HSU-MIN KUO, New Taipei (TW)

(21) Appl. No.: 15/495,989

(22) Filed: Apr. 25, 2017

(30) Foreign Application Priority Data
May 18, 2016 (CN) 201610333086.9

(51) Int. Cl. G08B 13/14; G08B 7/06; H02J 7/00; H04W 12/08

(52) U.S. Cl. CPC G08B 13/1418; H04W 12/08; G08B 7/06; H02J 7/0026; H02J 7/0045

(57) ABSTRACT

An anti-theft method includes controlling an electronic device to enter a locked status, when a charging interface of the electronic device and an I/O plug of a charger are interlocked, and a charging plug of the charger and a power outlet are interlocked. Once the electronic device is determined to be in an abnormal status according to a working status of a charging interface of the electronic device, a prompt is transmitted.

### CROSS-REFERENCE TO RELATED APPLICATIONS

This application claims priority to Chinese Patent Application No. 201610333086.9 filed on May 18, 2016, the contents of which are incorporated by reference herein.

### FIELD

The subject matter herein generally relates to anti-theft technology, and particularly to an electronic device and an anti-theft method.

### BACKGROUND

Generally, an electronic device (e.g., a mobile phone) is left unattended when the electronic device is charging. Thus, an opportunity is provided to a thief for stealing the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of an electronic device including an anti-theft system.

FIG. 2 illustrates an exemplary embodiment of the electronic device, a charger, and a power outlet.

FIG. 3 illustrates an exemplary embodiment of the electronic device electrically connecting with the power outlet through the charger.

FIG. 4 is a flowchart of an exemplary embodiment of a method of preventing theft of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” exemplary embodiment in this disclosure are not necessarily to the same exemplary embodiment, and such references mean “at least one.”

Furthermore, the term “module”, as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

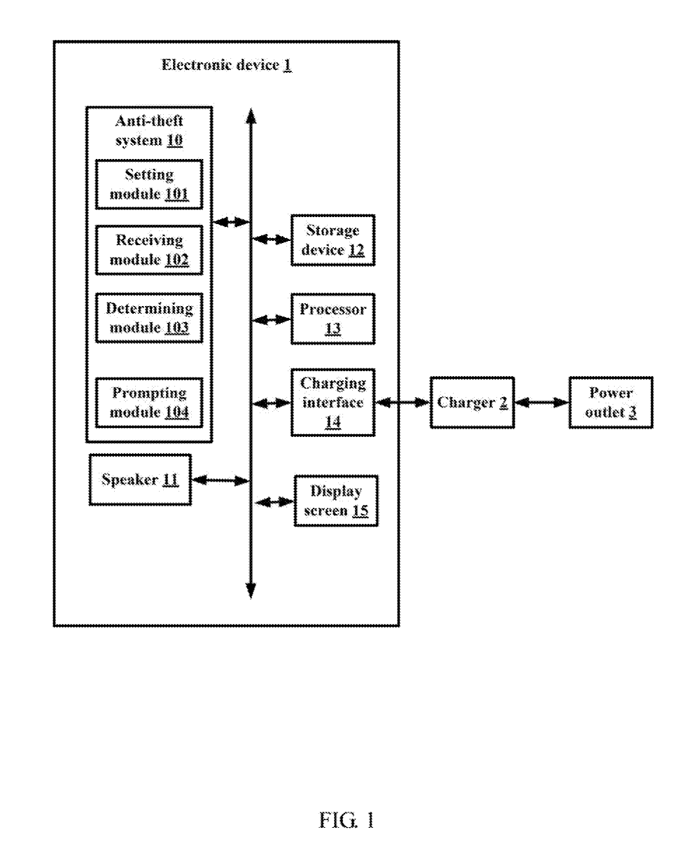

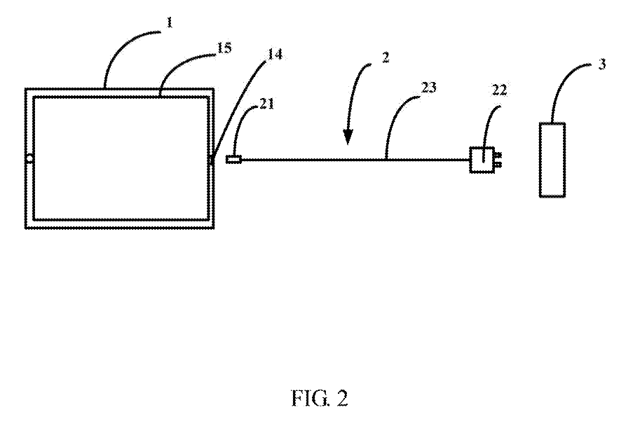

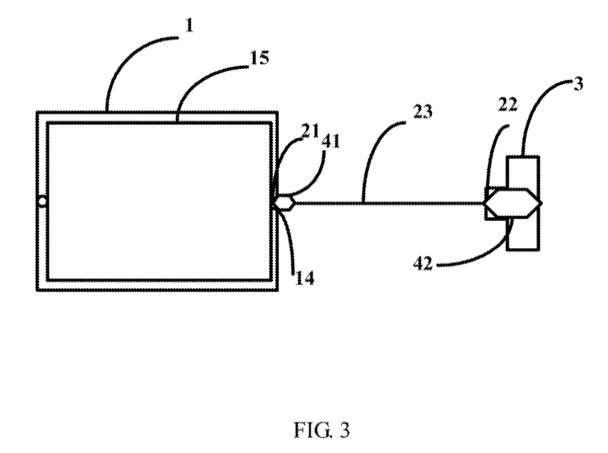

FIG. 1 is a block diagram of an exemplary embodiment of an electronic device including an anti-theft system. FIG. 2 illustrates the electronic device, a charger, and a power outlet. FIG. 3 illustrates the electronic device being electrically connected with the power outlet through the charger. Depending on the exemplary embodiment, an electronic device 1 can include, but is not limited to, an anti-theft system 10, a speaker 11, a storage device 12, at least one processor 13, a charging interface 14, and a display screen 15. The electronic device 1 can be a mobile phone, a tablet computer, a personal digital assistant, or any suitable device. It should be noted that the electronic device 1 may have a different configuration, other electronic devices may further include other elements such as an operating system, an electrical system, etc.

In at least one exemplary embodiment, the anti-theft system 10 can be used to protect the electronic device 1 from theft when the electronic device 1 is charging. The anti-theft system 10 can transmit a prompt when the electronic device 1 is in an abnormal status. In at least one exemplary embodiment, the anti-theft system 10 can transmit the prompt by controlling the speaker 11 to play an audio warning, thus a user of the electronic device 1 can be warned that the electronic device 1 is in the abnormal status. In other exemplary embodiments, the anti-theft system 10 can transmit the prompt by sending a predetermined message to a predetermined phone number. For example, the predetermined message can be “***, your mobile phone is being stolen!”.

In at least one exemplary embodiment, when an input/output (I/O) plug 21 of the charger 2 is plugged in the charging interface 14 of the electronic device 1, the I/O plug 21 and the electronic device 1 can be interlocked using a first interlocking mechanism 41. When a charging plug 22 of the charging 2 is plugged in the power outlet 3, the charging plug 22 and the power outlet 3 can be interlocked using a second interlocking mechanism 42. Additionally, to further prevent theft, a charging cable 23 of the charger 2 can be made of high strength and high toughness material. Thus, the charging cable 23 can be made cutting-resistant as against an unauthorized user or a thief.

It should be noted that the first interlocking mechanism 41 and the second interlocking mechanism 42 can be any type of interlocking mechanism in the art.

In at least one exemplary embodiment, the anti-theft system 10 can lock the display screen 15 when the electronic device 1 is charging. In at least one exemplary embodiment, when a working status of the charging interface 14 is switched from an on-charge status to a non-charging status when the display screen 15 is in a locked status, the anti-theft system 10 determines that the electronic device 1 is in the abnormal status. In at least one exemplary embodiment, the on-charge status can be defined be a status that current is inputting in the charging interface 14, and the non-charging status can be defined as a status that no current is inputting in the charging interface 14. For example, when the electronic device 1 is charging and an unauthorized user disconnects the electronic device 1 from the charger 2 by destroying the first interlocking mechanism 41 or the second interlocking mechanism 42, the working status of the charging interface 14 is switched from the on-charge status to the non-charging status. Under such conditions, the anti-theft system 10 can determine that the electronic device 1 is in the abnormal status. For another example, when the electronic device 1 is charging and the charging cable 23 is cut by the unauthorized user, then the working status of the charging interface 14 is switched from the on-charge status to the non-charging status when the display screen 15 is in a locked status, thus the anti-theft system 10 can determine that the electronic device 1 is in the abnormal status.

In other exemplary embodiments, when the display screen 15 is in the locked status, and the working status of the charging interface 14 is switched from the on-charge status to the non-charging status, the anti-theft system 10 can further determine whether the electronic device 1 is fully charged. When the electronic device 1 is not fully charged, the anti-theft system 10 can determine that the electronic device 1 is in the abnormal status, and can transmit the prompt. When the electronic device 1 is fully charged, the anti-theft system 10 determines that the electronic device 1 is in a normal status, then the prompt will not be transmitted by the anti-theft system 10.

In at least one exemplary embodiment, the display screen 15 can be a multi-touch panel such as a resistive touch screen or a capacitive touch screen.

The storage device 12 can be used to store all kinds of data such as codes of program instructions of the electronic device 1. In at least one exemplary embodiment, the storage device 12 can be an internal storage device such as a memory of the electronic device 1. In other exemplary embodiments, the storage device 12 can be external storage device of the electronic device 1. For example, the storage device 12 can be a secure digital card, a smart media card, or a flash card.

In at least one exemplary embodiment, the anti-theft system 10 can include a setting module 101, a receiving module 102, a determining module 103, and a prompting module 104. The modules 101-104 include computer instructions or codes in the form of one or more programs that may be executed by the at least one processor 13.

In at least one exemplary embodiment, when the charging interface 14 of the electronic device 1 and the I/O plug 21 of the charger 2 are interlocked, the charging plug 22 of the charger 2 and the power outlet 3 are interlocked, the setting module 101 can control the display screen 15 to enter the locked status.

In at least one exemplary embodiment, the setting module 101 can preset an unlocking password for unlocking the display screen 15. The setting module 101 can pre-store the unlocking password in the storage device 12.

In at least one exemplary embodiment, the unlocking password can be a character string that is composed by one or more characters, one or more Arabic numerals, and/or one or more special characters. The setting module 101 can provide a first user interface on the display screen 15, and can set the unlocking password in response to user input into the first user interface.

In other exemplary embodiments, the setting module 101 can display a first number of images on the first user interface, and the setting module 101 can set one or more images selected from the first number of images as the unlocking password. In other words, the unlocking password can be a selected predetermined image or a combination of a number of selected predetermined images.

In at least one exemplary embodiment, the setting module 101 can lock the display screen 15 in response to a predetermined signal.

In at least one exemplary embodiment, the predetermined signal can be a signal trigged by simultaneously pressing a power button and a home button of the electronic device 1.

In other exemplary embodiments, the setting module 101 can lock the display screen 15 immediately when the working status of charging interface 14 is switched from the non-charging status to the on-charge status.

In other exemplary embodiments, the setting module 101 can lock the display screen 15 when the electronic device 1 maintains a standby status for a predetermined time period such as 5 minutes.

In at least one exemplary embodiment, when the display screen 15 is in the locked status, the receiving module 102 can display a message on the display screen 15 that the display screen 15 should be unlocked before disconnecting the electronic device 1 from the charger 2.

In at least one exemplary embodiment, when the display screen 15 is in the locked status, the receiving module 102 can receive a password input by a user.

In at least one exemplary embodiment, when the display screen 15 is in the locked status, the receiving module 102 can display a second user interface for receiving the password input by the user. In at least one exemplary embodiment, when the unlocking password is the character string, the receiving module 102 can display a virtual keyboard when a touch signal or a clicking signal is received from the second user interface. The user can input the password using the virtual keyboard. Thus the receiving module 102 can receive the password input through the second user interface.

In at least one exemplary embodiment, when the unlocking password is the predetermined image or the combination of the number of predetermined images, the receiving module 102 can display the first number of images on the second user interface. The receiving module 102 can set one or more images selected from the first number of images displayed on the second user interface as the password input from the second user interface.

In at least one exemplary embodiment, when the password received by the receiving module 102 matches with the unlocking password stored in the storage device 12, the determining module 103 can unlock the display screen 15.

In at least one exemplary embodiment, the determining module 103 can determine whether the working status of the charging interface 14 is switched from the on-charge status to the non-charging status.

In at least one exemplary embodiment, when the display screen 15 is in the locked status, and the working status of the charging interface 14 is switched from the on-charge status to the non-charging status, the prompting module 104 can transmit the prompt. For example, the prompting module 104 can control the speaker to play the audio warning, or can send the predetermined message to the predetermined phone number.

In other exemplary embodiments, when the display screen 15 is in the locked status and the working status of the charging interface 14 is switched from the on-charge status to the non-charging status, and the electronic device 1 is not fully charged, the prompting module 104 can transmit the prompt.

For example, when the display screen 15 is locked, and an unauthorized user disconnects the electronic device 1 from the charger 2 by destroying the first interlocking mechanism 41 or the second interlocking mechanism, the working status of the charging interface 14 is then switched from the on-charge status to the non-charging status, the prompting module 104 can transmit the prompt.

For another example, when the display screen 15 is locked, and the unauthorized user disconnects the electronic device 1 from the charger 2 by cutting the charging cable 23, the working status of the charging interface 14 is then switched from the on-charge status to the non-charging status, the prompting module 104 can transmit the prompt.

In other exemplary embodiments, when the password received by the receiving module 102 does not match the unlocking password stored in the storage device 12, the determining module 103 can determine a number of times of wrong password being input. When the number of times equals a predetermined number of times (e.g., 5 times), the determining module 103 can determine the electronic device 1 is in the abnormal status, the prompting module 101 can transmit the prompt.

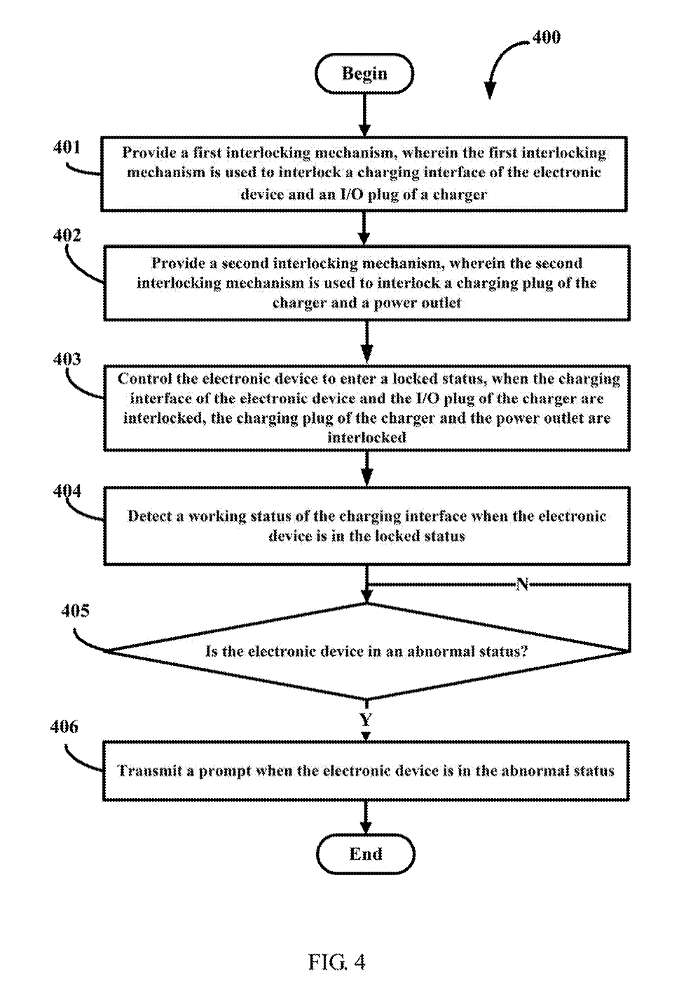

FIG. 4 illustrates an exemplary embodiment of a flowchart of an anti-theft method. The exemplary method 400 is provided by way of example, as there are a variety of ways to carry out the method. The method 400 described below can be carried out using the configurations illustrated in FIG. 1, for example, and various elements of these figures are referenced in explaining exemplary method 400. Each block shown in FIG. 4 represents one or more processes, methods, or subroutines, carried out in the exemplary method 400. Additionally, the illustrated order of blocks is by way of example only and the order of the blocks can be changed according to the present disclosure. The exemplary method 400 can begin at block 401. Depending on the exemplary embodiment, additional steps can be added, others removed, and the ordering of the steps can be changed.

At block 401, when the I/O plug 21 of the charger 2 is plugged in the charging interface 14 of the electronic device 1, the exemplary method 400 includes interlocking the charging interface 14 of the electronic device 1 and the I/O plug 21 using the first interlocking mechanism 41.

At block 402, when the charging plug 22 of the charging 2 is plugged in the power outlet 3, the exemplary method 400 includes interlocking the charging plug 22 of the charger 2 and the power outlet 3 using the second interlocking mechanism 42.

At block 403, the setting module 101 can control the display screen 15 to enter the locked status.

In at least one exemplary embodiment, the setting module 101 can preset an unlocking password for unlocking the display screen 15. The setting module 101 can pre-store the unlocking password in the storage device 12.

In at least one exemplary embodiment, the unlocking password can be a character string that is composed by one or more characters, one or more Arabic numerals, and/or one or more special characters. The setting module 101 can provide a first user interface on the display screen 15, and can set the unlocking password in response to user input into the first user interface.

In other exemplary embodiments, the setting module 101 can display a first number of images on the first user interface, and the setting module 101 can set one or more images selected from the first number of images as the unlocking password. In other words, the unlocking password can be a selected predetermined image or a combination of a number of selected predetermined images.

In at least one exemplary embodiment, the setting module 101 can lock the display screen 15 in response to a predetermined signal.

In at least one exemplary embodiment, the predetermined signal can be a signal trigged by simultaneously pressing a power button and a home button of the electronic device 1.

In other exemplary embodiments, the setting module 101 can lock the display screen 15 immediately when the working status of charging interface 14 is switched from the non-charging status to the on-charge status.

In other exemplary embodiments, the setting module 101 can lock the display screen 15 when the electronic device 1 maintains on a standby status for a predetermined time period such as 5 minutes.

At block 404, when the display screen 15 is in the locked status, the determining module 103 can detect the working status of the charging interface 14. In at least one exemplary embodiment, the determining module 103 can detect the working status of the charging interface 14 at every predetermined time interval (e.g., at every 2 seconds).

In at least one exemplary embodiment, when the display screen 15 is in the locked status, the receiving module 102 can display a message on the display screen 15 that the display screen 15 should be unlocked before disconnecting the electronic device 1 from the charger 2.

In at least one exemplary embodiment, when the display screen 15 is in the locked status, the receiving module 102 can receive a password input by a user.

In at least one exemplary embodiment, when the display screen 15 is in the locked status, the receiving module 102 can display a second user interface for receiving the password input by the user. In at least one exemplary embodiment, when the unlocking password is the character string, the receiving module 102 can display a virtual keyboard when a touch signal or a clicking signal is received from the second user interface. The user can input the password using the virtual keyboard. Thus the receiving module 102 can receive the password input through the second user interface.

In at least one exemplary embodiment, when the unlocking password is the predetermined image or the combination of the number of predetermined images, the receiving module 102 can display the first number of images on the second user interface. The receiving module 102 can set one or more images selected form the first number of images displayed on the second user interface as the password input from the second user interface.

In at least one exemplary embodiment, when the password received by the receiving module 102 matches with the unlocking password stored in the storage device 12, the determining module 103 can unlock the display screen 15.

At block 405, the determining module 103 can determine whether the electronic device 1 is in the abnormal status according to the working status of the charging interface 14. When the electronic device 1 is in the abnormal status, the process goes to block 406. When the electronic device 1 is in the normal status, the block 405 is re-executed.

In at least one exemplary embodiment, when the display screen 15 is in the locked status, and the working status of the charging interface 14 is switched from the on-charge status to the non-charging status, the determining module 103 can determine the electronic device 1 is in the abnormal status. When the display screen 15 is in the locked status, and the working status of the charging interface 14 is in the on-charge status, the determining module 103 can determine the electronic device 1 is in the normal status.

For example, when the display screen 15 is locked, an unauthorized user disconnects the electronic device 1 from the charger 2 by destroying the first interlocking mechanism 41 or the second interlocking mechanism, the working status of the charging interface 14 is then switched from the on-charge status to the non-charging status, the determining module 103 can determine that the electronic device 1 is in the abnormal status.

For another example, when the display screen 15 is locked, the unauthorized user disconnects the electronic device 1 from the charger 2 by cutting the charging cable 23, the working status of the charging interface 14 is then switched from the on-charge status to the non-charging status, the determining module 103 can determine that the electronic device 1 is in the abnormal status.

In other exemplary embodiments, when the display screen 15 is in the locked status, and the working status of the charging interface 14 is switched from the on-charge status to the non-charging status, the determining module 103 can further determine whether the electronic device 1 is fully charged. When the electronic device 1 is not fully charged, the determining module 103 can determine that the electronic device 1 is in the abnormal status. When the electronic device 1 is fully charged, the anti-theft system 10 determines that the electronic device 1 is in the normal status.

At block 406, the prompting module 104 can transmit the prompt.

For example, the prompting module 104 can transmit the prompt by controlling the speaker to play the audio warning, or can transmit the prompt by sending the predetermined message to the predetermined phone number.

It should be emphasized that the above-described exemplary embodiments of the present disclosure, including any particular exemplary embodiments, are merely possible examples of implementations, set forth for a clear understanding of the principles of the disclosure. Many variations and modifications can be made to the above-described exemplary embodiment(s) of the disclosure without departing substantially from the spirit and principles of the disclosure. All such modifications and variations are intended to be included herein within the scope of this disclosure and protected by the following claims.

What is claimed is:

1. An anti-theft method applied to an electronic device, the method comprising:
providing a first interlocking mechanism, wherein the first interlocking mechanism is used to interlock a charging interface of the electronic device and an I/O plug of a charger;
providing a second interlocking mechanism, wherein the second interlocking mechanism is used to interlock a charging plug of the charger and a power outlet;
when the charging interface of the electronic device and the I/O plug of the charger are interlocked, the charging plug of the charger and the power outlet are interlocked, controlling the electronic device to enter a locked status;
detecting a working status of the charging interface when the electronic device is in the locked status;
determining whether the electronic device is in an abnormal status according to the working status of the charging interface; and
transmitting a prompt when the electronic device is in the abnormal status.

2. The method according to claim 1, further comprising:
providing a user interface for receiving a password input by a user when the electronic device is in the locked status; and
unlocking the electronic device when the received password matches with a preset unlocking password.

3. The method according to claim 1, wherein the electronic device enters the locked status when a working status of the charging interface is switched from a non-charging status to an on-charge status.

4. The method according to claim 1, wherein the prompt is transmitted by controlling a speaker to play an audio warning, or the prompt is transmitted by sending a predetermined message to a predetermined phone number.

5. The method according to claim 1, wherein when the electronic device is in the locked status, and the working status of the charging interface is switched from an on-charge status to a non-charging status, the electronic device is determined to be in the abnormal status.

6. The method according to claim 1, wherein when the electronic device is in the locked status, the working status of the charging interface is switched from an on-charge status to a non-charging status, and the electronic device is not fully charged, the electronic device is determined to be in the abnormal status.

7. An electronic device, comprising:
a storage device; and
at least one processor, wherein the storage device stores one or more programs that, when executed by the at least one processor, cause the at least one processor to:
control the electronic device to enter a locked status, when a charging interface of the electronic device and an I/O plug of a charger are interlocked, and a charging plug of the charger and a power outlet are interlocked;
detect a working status of the charging interface when the electronic device is in the locked status;
determine whether the electronic device is in an abnormal status according to the working status of the charging interface; and
transmit a prompt when the electronic device is in the abnormal status.

8. The electronic device according to claim 7, wherein the at least one processor is further caused to:
provide a user interface for receiving a password input by a user when the electronic device is in the locked status; and
unlock the electronic device when the received password matches with a preset unlocking password.

9. The electronic device according to claim 7, wherein the electronic device enters the locked status when a working status of the charging interface is switched from a non-charging status to an on-charge status.

10. The electronic device according to claim 7, wherein the prompt is transmitted by controlling a speaker to play an audio warning, or the prompt is transmitted by sending a predetermined message to a predetermined phone number.

11. The electronic device according to claim 7, wherein when the electronic device is in the locked status, and the working status of the charging interface is switched from an on-charge status to a non-charging status to, the electronic device is determined to be in the abnormal status.

12. The electronic device according to claim 7, wherein when the electronic device is in the locked status, the working status of the charging interface is switched from an on-charge status to a non-charging status, and the electronic device is not fully charged, the electronic device is determined to be in the abnormal status.

13. A non-transitory storage medium having stored thereon instructions that, when executed by a processor of an electronic device, causes the processor to perform an anti-theft method, the method comprising:
controlling the electronic device to enter a locked status, when a charging interface of the electronic device and an I/O plug of a charger are interlocked, and a charging plug of the charger and a power outlet are interlocked;
detecting a working status of the charging interface when the electronic device is in the locked status;
determining whether the electronic device is in an abnormal status according to the working status of the charging interface; and
transmitting a prompt when the electronic device is in the abnormal status.

14. The non-transitory storage medium according to claim 13, wherein the method further comprises:
providing a user interface for receiving a password input by a user when the electronic device is in the locked status; and
unlocking the electronic device when the received password matches with a preset unlocking password.

15. The non-transitory storage medium according to claim 13, wherein the electronic device enters the locked status when a working status of the charging interface is switched from a non-charging status to an on-charge status.

16. The non-transitory storage medium according to claim 13, wherein the prompt is transmitted by controlling a speaker to play an audio warning, or the prompt is transmitted by sending a predetermined message to a predetermined phone number.

17. The non-transitory storage medium according to claim 13, wherein when the electronic device is in the locked status, and the working status of the charging interface is switched from an on-charge status to a non-charging status, the electronic device is determined to be in the abnormal status.

18. The non-transitory storage medium according to claim 13, wherein when the electronic device is in the locked status, the working status of the charging interface is switched from an on-charge status to a non-charging status, and the electronic device is not fully charged, the electronic device is determined to be in the abnormal status.
